(19) United States
(12) Patent Application Publication
(10) Pub. No.: US 2025/0222682 A1
(43) Pub. Date: Jul. 10, 2025

(54) COMPOSITE PANE

(71) Applicant: AGC GLASS EUROPE, Louvain-la-Neuve (BE)

(72) Inventors: Tokihiko AOKI, Gosselies (BE); Kadosa HEVESI, Namur (BE)

(73) Assignee: AGC GLASS EUROPE, Louvain-la-Neuve (BE)

(21) Appl. No.: 18/727,755

(22) PCT Filed: Feb. 21, 2023
(86) PCT No.: PCT/EP2023/054315

§ 371 Date: Jul. 10, 2024

(30) Foreign Application Priority Data
Mar. 15, 2022 (EP) 22162302.8

(51) Int. Cl. B32B 17/10

(52) U.S. Cl. CPC B32B 17/10201; B32B 17/10036; B32B 2272/00; B32B 2307/204; B32B 2307/412

(57) ABSTRACT

A composite pane having an IR reflective coating and a low emissivity coating and a method to provide for the pane and to uses thereof.

The invention relates to a composite pane having IR reflective coating and low emissivity coating, to a method to provide for said pane and to uses thereof.

Composite panes having sun protection are known in the art.

EP1060876A2 relates to a glazing which includes at least two glass pieces joined by a thermoplastic layer and a solar protection layer which reflects radiation outside the visible spectrum of solar radiation, especially infrared rays. A transparent, low-emission layer that reflects thermal radiation is located more towards the interior than the solar protection layer. The thermal radiation reflecting layer is a layer of doped metal oxide, especially fluorine-doped tin oxide, preferably deposited by pyrolysis, and has at least one sublayer and/or at least one over-layer, and especially a mechanically resistant protection layer. The solar protection layer comprises a stack of layers including at least one metal layer incorporated between two layers of metal oxide or nitride, e.g. AlN or Si₃N₄, in particular at least one silver-based layer. The glazing may be used as a windscreen, a side window, a rear window or roof of a car vehicle.

WO2016/184732A1 relates to a pane for separating an interior from an outer environment, at least comprising a substrate (1), a thermal-radiation-reflecting coating (2) on the interior-side surface (i) of the substrate (1), which coating has at least one functional layer (2a) containing a transparent conductive oxide (TCO) and the topmost layer (2b) of which coating contains silicon dioxide (SiO₂), and a polymeric fastening or sealing element (3) on the thermal-radiation-reflecting coating (2).

WO2019/110172 relates to a composite pane, comprising: an outer pane (1), which has an outer surface (1) and an interior-side surface (II); an inner pane (2), which has an outer surface (III) and an interior-side surface (IV); and a thermoplastic interlayer (3), which connects the interior-side surface (II) of the outer pane (1) to the outer surface (III) of the inner pane (2), the composite pane having at least one sun protection coating (4) between the outer pane (1) and the inner pane (2), which sun protection coating reflects or absorbs mainly radiation outside of the visible spectrum of the solar radiation, in particular infrared radiation, and the composite pane having, on the interior-side surface (IV) of the inner pane (2), a thermal-radiation-reflecting coating (5) (low-E coating), characterized in that the composite pane has a transmittance index A of 0.02 to 0.08, the transmittance index A being determined according to the following formula (I): A=TL_{composite glass pane/(TLlow-E-coated pane*TE)}(I), TL being the light transmittance and TE being the energy transmission measured according to ISO 9050.

Glazings such as those used in sunroofs and sliding roofs require light transmittance between 2 and 10% and specific sun protection.

The provision of such low light transmittance is that an obscuration sheet must be present in the laminated glazing. Such sheet may be a tinted glass sheet, or a tinted thermoplastic interlayer.

Typically tinted thermoplastic interlayer contains pigments and dyes which may be degraded by the effects of the sun and heat. Degradation of the contents of the tinted thermoplastic interlayer may also cause loss of adhesion and loss of cohesive strength within the tinted thermoplastic interlayer. This is especially true when tinted thermoplastic interlayer are provided from recycled thermoplastic material.

Recycled thermoplastic materials may be obtained by the reprocessing of used materials and/or of left-overs of fresh thermoplastic materials, obtained after cutting and sizing for example. Disassembly and recovery of individual components of laminated glazing are known since the early 1990's. While recycling composite materials was not considered seriously in the past, the situation today has changed, in view of the growing concern for environmental issues associated with industrial applications. Recycled thermoplastic materials are typically provided from a mix of used interlayers and/or interlayer scraps from different suppliers.

Despite technological efforts in the field of the recycling of thermoplastic materials, some recycled materials fail to exhibit the exact same properties as the original materials, also named “virgin” or “fresh” materials. The main problem with such recycled material is the lack of chemical stability due to their different origins. Recycled materials with two or more compositions means there are different chemistries in terms of basic interlayer resin, type and amount of plasticizer or adhesion control ions mixed into one product. Minor or no sorting is carried out such that the exact chemical composition of the recycled material may not be consistent over time.

This was found to be problematic in particular for laminated coated glass, where adhesion properties and resistance to breakage were found to suffer from quality losses due to heating of the thermoplastic interlayer due to solar rays. This problem did not occur when using “virgin” PVB with standard coatings developed to date. This risk in production can not be tolerated.

While minor losses in the quality of the recycled materials may be accepted, minor losses in safety may not be tolerated.

Coated glass substrates are well known in the field of laminated glazing. The coatings may provide for solar control, heat control or other functionalities. Such coated glass substrates may be used in laminated form, using thermoplastic materials. With the rise of the recycled thermoplastic materials, it actually appeared that some of these materials failed to exhibit consistent quality in the adhesion with coated glass substrates.

For the long term use of a vehicle, it is thus critical the roof and windows have a life span of more than 10 years at least, despite the presence of recycled thermoplastic material.

The objective is, consequently, to provide for a composite pane with current requirements in terms of thermal management, light management, with a long shelf life, comprising at least one thermoplastic interlayer comprising at least 10% recycled material.

The composite pane therefore is targeted to possess the following characteristics:
a light transmittance of 1 to 10% in order to ensure the best possible compromise between vision outside through the roof and good thermal properties;
a light reflectance observed from the outside Rext<13%;
a light reflectance observed from the inside Rin<8%.

The composite pane is expected to have a shelf-life of at least 10 years.

This object is accomplished according to the invention by a composite pane according to claim 1.

The composite pane is intended, in a window opening, to separate an interior space, in particular the interior of a vehicle from the external environment. The composite pane is a laminate and comprises a first pane and a second pane that are referred to in the context of the invention as “outer pane” and “inner pane” and are joined to one another via a thermoplastic interlayer. In the context of the invention “inner pane” is the pane that faces the interior in the installed position. “Outer pane” refers to the pane facing the external environment in the installed position. “Interior-side surface (or inside or inner surface)” means, in the context of the invention, that surface of the panes that faces the interior in the installed position. “Outer-side surface (outside or outer surface)” means, in the context of the invention, that surface of the panes that faces the external environment in the installed position.

The surfaces of the panes are typically referenced as follows. The outer side of the outer pane is referred to as side 1. The inner-side of the outer pane is referred to as side 2. The outer side of the inner pane is referred to as side 3. The inner-side of the inner pane is referred to as side 4. The interior-side surface of the outer pane and the outer-side surface of the inner pane face one another and are bonded to one another by means of the thermoplastic interlayer.

The outer and inner panes may independently be a glass sheet, or a plastic sheet comprising or consisting of poly(methyl meth)acrylate (PMMA), polycarbonates, polyethyleneterephthalate (PET), polyolefins, polyvinyl chloride (PVC), or mixtures thereof.

In most instances, at least one of the outer and inner panes is a glass substrate. It is however preferred that the outer and inner panes both be glass substrates.

The glass may be of any type, such as conventional float glass or flat glass, and may be of any composition having any optical properties, e.g., any value of visible transmission above 10%, ultraviolet transmission, infrared transmission, and/or total solar energy transmission.

The glass may thus be a glass of soda-lime-silica, aluminosilicate or borosilicate type, and the like. The glass composition typically comprises the following components (Comp. A). In all glass compositions described herein, the levels are in expressed in weight percentage, or in weight ppm expressed with respect to the total weight of glass.

The glass may be a regular clear, colored or extra-clear (i.e. lower iron content and higher transmittance) glass substrate. Further examples of glass substrates include clear, green, bronze, or blue-green glass substrates.

Preferred glass substrates for the inner and outer panes may be selected from clear or extra-clear soda-lime glass. These typically have a light transmittance of at least 89% (for a glass sheet thickness of 4 mm). They may be qualified as colorless when looking through their main faces. These clear glass types have the major advantage of not building up heat and thus of reducing heat absorption from the sun rays, which in turn reduces the need for air conditioning within the vehicle. Specially, when the outer glass sheet is such a high transmissive glass sheet, the IR reflective layer present in the composite pane may be fully efficient in reflecting heat rays, such that heat is not absorbed within the glass sheet, and thermal management is optimized.

The typical composition of soda-lime-silicate-type glass (Comp. B) is as follows:

| | Comp. A | Comp. B |
|---|---|---|
| SiO₂ | 40-78% | 60-78 wt % |
| Al₂O₃ | 0-18% | 0-8 wt %, pref 0-6 wt % |
| B₂O₃ | 0-18% | 0-4 wt %, pref 0-1 wt % |
| Na₂O | 0-20% | 5-20 wt %, pref 10-20 wt % |
| CaO | 0-15% | 0-15 wt %, pref 5-15 wt % |
| MgO | 0-15% | 0-10 wt %, pref 0-8 wt % |
| K₂O | 0-15% | 0-12 wt %, pref 0-10% |
| BaO | 0-5% | 0-5 wt %, pref 0-1 wt %. |

In the art, “ultra-white” or “extra-clear” or “low iron” glasses are known since years in the solar or building domain, due to their high luminous and/or energy transmittance (at least 90% for a glass sheet thickness of 4 mm). These glasses contain low amount of iron such as 0.002-0.06% wt, preferably 0.002-0.04% wt, more preferably 0.002-0.02% wt of total iron (expressed as Fe₂O₃).

Examples of suitable clear soda-lime glass include those glass types having a high transmission in the infrared wavelength, obtained by the addition of specific oxidants such chromium oxide, cobalt oxide, selenium oxide, manganese oxide and/or cerium oxide to the base soda-lime composition. For example, a glass composition comprising, in a content expressed in percentages in total weight of glass:total iron (expressed as Fe₂O₃) at a level of 0.002-0.06% wt; and Cr₂O₃ at a level of 0.0001-0.06% wt, preferably 0.002 to 0.06% wt; or a glass composition comprising, in a content expressed in percentages in total weight of glass: 0.0015-1% wt of Cr₂O₃ and 0.0001-1% wt of Co; or a glass composition comprising, in a content expressed in percentages in total weight of glass:total iron (expressed as Fe2O3) at a level of 0.02-1% wt, preferably 0.06-1% wt, Cr2O3 at a level of 0.002-0.5% wt; and Co at a level of 0,0001-0.5% wt. Alternative solutions to obtain a low iron glass with a very high transmission in the infrared can use cerium oxide (0.001-1% wt) and/or a combination of known oxidant such as manganese (MnO from 0.01 to 1% wt), antimony (Sb2O3 from 0.01 to 1% wt), arsenic (As2O3 from 0.01 to 1% wt), and/or copper (CuO from 0.0002 to 0.1% wt). The composition will be selected such that the glass sheet is clear glass.

Further examples of suitable clear soda-lime glass include those which have been formulated to be easily chemically temperable—more favorable to ion exchange than conventional soda-lime-silica glass compositions while remaining easy to produce, in particular on an existing line of production of classical soda-lime-silica glass. Such glass composition may comprise the following components—Compositions C to E. Preferably, these glasses contain low amount of iron such as 0,0001-0.06% wt, preferably 0.002-0.04% wt, more preferably 0.002-0.02% wt of total iron (expressed as Fe₂O₃).

| Comp. C | Comp. D | Comp. E |
|---|---|---|
| 65 ≤ SiO₂ ≤ 78 wt % | 60 ≤ SiO₂ ≤ 78% | 65 ≤ SiO₂ ≤ 78 wt % |
| 5 ≤ Na₂O ≤ 20 wt % | 5 ≤ NaO ≤ 20% | 5 ≤ Na₂O ≤ 20 wt % |
| 0 ≤ K₂O < 5 wt % | 0.9 < K₂O ≤ 12% | 1 ≤ K₂O < 8 wt % |
| 1 ≤ Al₂O₃ < 6 wt %, | 4.9 ≤ Al₂O₃ ≤ 8% | 1 ≤ Al₂O₃ < 6 wt % |
| pref 3 < Al₂O₃ ≤ 5% | | |
| 0 ≤ CaO < 4.5 wt % | 0.4 < CaO < 2% | 2 ≤ CaO < 10 wt % |
| 4 ≤ MgO ≤ 12 wt % | 4 < MgO ≤ 12% | 0 ≤ MgO ≤ 8 wt % |
| (MgO/(MgO + CaO)) ≥ 0.5, pref | | K₂O/(K₂O + Na₂O): 0.1-0.7 |
| 0.88 ≤ [MgO/(MgO + CaO)] < 1 | | |

Yet further examples of suitable clear soda-lime glass include those which have been formulated to provide high luminous transmittance as well as edges which are colorless/achromatic. Such glass composition may comprise the following components, in a content expressed in percentages in total weight of glass: 0.002-0.04% wt of total iron (expressed in the form of Fe₂O₃) at a redox ratio s 32%, 0.003-0.1% wt of erbium (expressed in the form of Er₂O₃) and wherein: 1.3*Fe₂O₃≤Er₂O₃-21.87*Cr₂O₃−53.12*Co≤2.6*Fe₂O₃.

Another example of clear soda-lime glass composition may comprise the following components, in a content expressed in percentages in total weight of glass:total iron (expressed as Fe₂O₃) at a level of 20-750 ppm; Selenium (expressed as Se) at a level of 0.1-<3 ppm; Cobalt (expressed as Co) at a level of 0.05-5 ppm; and a ratio of Er₂O₃/Fe₂O₃ at a level of 0.1-1.5.

The glass may be annealed, tempered or heat strengthened glass.

The outer and inner panes may independently have a thickness ranging from 0.5 mm to 15 mm, alternatively from 0.5 mm to 10 mm, alternatively from 0.5 mm to 8 mm, alternatively from 0.5 mm to 6 mm.

The outer and inner panes in the present composite pane may have a thickness ranging from 0.5 to 4 mm.

Both panes may have the same thickness, for example 0.5 mm, or 0.8 mm, or 1.2 mm, or 1.6 mm, or 2.1 mm, or 3 mm. Such symmetrical construction in glass thickness allows for ease of process and conventional sizing of the laminating process.

Both panes may also have different thicknesses, providing for asymmetrical laminated glazings, for example pane 1=0.5 mm and pane 2=2.1 mm, or pane 1=0.8 mm and pane 2=2.1 mm, or pane 1=0.5 mm and pane 2=1.6 mm, pane 1=0.8 mm and pane 2=1.6 mm, or pane 1=1.6 mm and pane 2=2.1 mm. Such asymmetrical constructions in glass thickness allow for flexibility in curvature, and/or in weight management and/or flexibility in light/solar modulation.

The terms “polymer interlayer sheet,” “interlayer,” “interlayer” as used herein, generally may designate a single-layer sheet or a multilayered interlayer. A “single-layer sheet,” as the name implies, is a single or monolithic thermoplastic layer extruded as one layer which is then used to laminate two panes. A multilayered interlayer, on the other hand, may comprise multiple layers, including separately extruded layers, co-extruded layers, or any combination of separately and co-extruded layers of thermoplastic material. Thus a multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; a combination of at least one plural-layer sheet and at least one co-extruded sheet, or any other combination of sheets as desired.

The thermoplastic interlayer may thus be formed by one or a plurality of thermoplastic films, wherein at least one film comprises at least 10% recycled material.

The thermoplastic film layer comprising at least 10% of recycled material may thus be obtained by methods known in the art, and which are not the subject of the present invention. The recycling process of the thermoplastic material typically occurs through shredding, crushing and washing, with solvents and or water, for separation of the glass and thermoplastic material, then separation of said material from other chemicals present (stabilizers, plasticizers, dyes, etc.), followed by extraction and/or filtration. The thermoplastic material obtained may then be used again using an alcoholic process for example. Various methods exist, which lead to materials having chemical and physical properties similar or equal to standard (fresh/virgin) material. It is upon use, that characterization of dissimilarities appear, with modified behavior towards the heat and solar rays, depending on the composition of the thermoplastic film material, such as pigments and dyes and additives, or that varying appearances may be observed.

Recycled material in the scope of the present invention entails those materials provided from different interlayer products or producers, collected after at least one first use, and encompasses recovered material from remainders of a lamination process, waste rolls, or surplus materials. That is, thermoplastic film layers that have been processed within a lamination step, and are cut off from final laminates, may be recovered and gathered to be mixed and reprocessed to furnish recycled material. Such recycled material typically is the result of a mixture of various sources of initial material, such that chemical composition is more varied than for “fresh” or “virgin” thermoplastic film layer. Indeed, “fresh” or “virgin” thermoplastic materials will typically have a reproducible and calibrated composition, consistent and constant over time, as the result of specific chemical compositions and the presence of specific ions will thus be defined by their origin and supplier. The thermoplastic materials typically contain metal salts or preferable alkali metallic salt or even more preferably alkaline-earth metal salt, typically used as adhesive force regulating agents to keep an adequate adhesion between glass and “fresh” thermoplastic film and so to ensure adhesion of the material to glass panes.

For example, “fresh” thermoplastic material (PVB) from one PVB sheet manufacturing company may be characterized by the presence of Mg and Na ions, or by the presence of Mg and K ions; while a “fresh” thermoplastic material (PVB) from another PVB sheet manufacturing company may be characterized by the presence of K and S ions, in addition to Mg and Na ions.

On the other hand, recycled materials will typically contain waste of various initial fresh thermoplastic materials from different commercial sources and thus different compositions, such that their combination after recycling will have fluctuating composition, from one batch to another, and will contain a broader variety of ions than the original and fresh thermoplastic materials, as being the result of a mixture of different sources.

The recycled material useful in the present invention may typically be characterized by a composition comprising a wide and fluctuant variety of ions, comprising at least the ions of Mg, Na, K, S, P, Li, Rb, Cs, Ca, Sr and Ba. These ions are thus the residuals of the mixtures of the metal salts retrieved from the original “fresh” or “virgin” thermoplastic film layer after the recycling procedure.

Although thermoplastic film layers comprising at least 10% of recycled material are designed to have similar properties to standard/fresh materials, experience has shown that thermoplastic film layers comprising at least 10% of recycled material may have varying ions concentration from one batch to another. Without wishing to be bound by theory, it is believed that such varying chemical composition may be the root cause of the varying adhesion performance to the panes and varying stability towards pigments and/or colorants. A lower compatibility on the material may ultimately lead to a safety issue such as lower adhesion over time and/or color degradation and/or loss of aesthetics over time. A varying composition may also be causing fluctuating appearance.

In the scope of the present invention, the thermoplastic interlayer is formed from at least one thermoplastic film layer comprising at least 10% of recycled material, alternatively at least 20% of recycled material, alternatively at least 60% of recycled material, alternatively 100% of recycled material. Typically, the remainder of the thermoplastic interlayer may be formed of film layers of virgin material; which may be the same type or a different from the at least one thermoplastic film layer comprising at least 10% of recycled material.

In some instances, the thermoplastic interlayer is formed only of thermoplastic film layers comprising at least 10% of recycled material, which may have the same or different compositions.

In other instances, the thermoplastic interlayer is a thermoplastic film layer comprising at least 10% of recycled material, alternatively at least 20% of recycled material, alternatively at least 60% of recycled material, alternatively 100% of recycled material.

Typical materials for the thermoplastic interlayer include, but are not limited to, polyvinyl acetal, polyvinyl butyral, polyurethane, poly(ethylene-co-vinyl acetate), polyvinylchloride, poly(vinylchloride-co-methacrylate), polyethylenes, polyolefins, ethylene acrylate ester copolymers, poly(ethylene-co-butyl acrylate), silicone elastomers, epoxy resins, and acid copolymers.

The thermoplastic films preferably contain polyvinyl butyral (PVB), ethylene vinyl acetate (EVA), polyurethane (PU) and/or mixtures thereof and/or copolymers thereof, particularly preferably polyvinyl butyral.

The films are preferably based on the materials mentioned but can, however, contain other components, for example, plasticizers, photophores, heat insulating particles, infrared absorbing particles, polymer-dispersed liquid crystals, suspended particles, pigments, colorants, or UV absorbers, preferably with a content of less than 50%.

The at least one thermoplastic film layer comprising at least 10% of recycled material has a light transmittance of from 1 to 20%, as measured by Illuminant A, with a 2° observer, preferably of from 1 to 15%, more preferably of from 1 to 10%, most preferably of from 1 to 8%. As is well known in the art, the light transmittance of a thermoplastic film layer may be calculated from the value of light transmittance of a laminated form of said thermoplastic film layer of 0.76 mm between two sheets of clear glass of 2.1 mm, according to norm EN 410 (2011). A modification in the thickness of the glass sheets may typically impact the light transmittance of the thermoplastic film layer by maximum 0.01%.

The lesser the light transmittance of the thermoplastic film layer, the better the protection of the interior compartment comfort while still allowing some visibility through the composite pane.

The use of a thermoplastic polymer film comprising at least 10% of recycled material having such light transmittance allows for the final composite pane to reach a light transmittance of 1 to 10%, preferably of 1% to 7% (measured with Illuminant A, 2°).

The individual thermoplastic film layer preferably have a thickness of about 0.2 mm to 1 mm, for example, 0.38 mm or 0.76 mm.

Examples of thermoplastic film layer of polyvinylbutyral comprising at least 10% of recycled material include Trosifol® from Kuraray Corp., Butacite®G from Dupont, Butvar or Saflex® from Eastman, or products from Sekisui Corp.

The at least one infrared reflective coating and the low emissivity coating of the present invention are provided as thin film coatings, having each independently a thickness ranging from 10 to 1000 nm.

When discussing the IR reflective coating and the low emissivity coating in the present invention, it is typically understood that the layers are numbered in sequence starting from the substrate surface. That is, a first layer is understood to be the first applied on the substrate, a second being the second layer applied on the substrate, above the first layer. The successive order of the positions is considered relative to the substrate onwards, up to the uppermost layer.

In the scope of the present invention, the terms “below”, “underneath”, “under” indicate the relative position of a layer vis a vis a next layer, within the layer sequence starting from the substrate. In the scope of the present invention, the terms “above”, “upper” indicate the relative position of a layer vis a vis a next layer, within the layer sequence starting from the substrate.

In the scope of the present invention, the relative positions of the layers within the stack do not necessarily imply direct contact between the layers. That is, some interlayer may be provided between the first and second layer. For example, a first layer “deposited over” the substrate does not preclude the presence of one or more other coating layers of the same or different composition located between that first layer film and the substrate, provided the objective of the present invention is not jeopardized.

In some instances, a layer may actually be composed of several multiple individual layers.

Unless stated otherwise, all layer thicknesses herein are geometrical layer thicknesses.

According to the invention, a low emissivity coating is applied on the interior-side of the inner pane (side 4). Such low emissivity coating reflects thermal radiation, i.e., in particular, IR radiation of longer wavelength than the IR component of solar radiation. At low outside temperatures, the low emissivity coating reflects heat back into the interior and reduces the cooling of the interior. At high outside temperatures in the summer, the low emissivity coating on the interior side of the inner pane reduces the emission of thermal radiation from the pane into the interior while it reduces the emission of heat into the external environment in the winter.

The low emissivity coating comprises at least one functional layer that contains a transparent conductive oxide (TCO), selected from indium tin oxide, antimony-doped or fluorine-doped tin oxide, gallium- and/or aluminum-doped zinc oxide, mixed indium zinc, vanadium oxide, tungsten and/or magnesium doped vanadium oxide, niobium-doped titanium oxide, cadmium stannate and/or zinc stannate.

Preferred transparent conductive oxide (TCO) may be selected from indium tin oxide, antimony-doped or fluorine-doped tin oxide and/or aluminum-doped zinc oxide (ZnO:Al) and/or gallium-doped zinc oxide (ZnO:Ga), with indium tin oxide or fluorine-doped tin oxide most preferred.

The refractive index of the material of the TCO functional layer is preferably 1.7 to 2.5.

The emissivity of the pane according to the invention can be influenced by the thickness of the functional layer of the low emissivity coating. The thickness of the at least one functional layer may range of from 75 nm to 210 nm, preferably 90 nm to 175 nm, and most preferably 105 nm to 170 nm. This range allows for an optimal compromise between a low emissivity and thermal treatment resistance of the pane. In the scope of the present invention, the low emissivity coating may be characterized by an emissivity<0.2 (according to the standard EN 12898).

A first suitable low emissivity coating includes a coating comprising the following layers, in sequence: a first low refractive index layer, for example silicon oxide, and a transparent conductive oxide layer.

This first suitable low emissivity coating allows to reach a light reflectance inside the vehicle, Rin, <10% or even <8%.

In a second suitable low emissivity coating, the at least one TCO functional layer may be surrounded by dielectric layers which may have alternating low and high refractive indices. In particular, the first dielectric layer, that is, the layer under the TCO functional layer, may comprise a first sublayer of high refractive index material, and subsequently, a second sublayer of low refractive index material. The second dielectric layer, that is, the layer above the TCO functional layer, may comprise a third sublayer of high refractive index material, and subsequently, a fourth sublayer of low refractive index material.

Examples of high refractive index dielectric layers, that is, with a refractive index>1.7, alternatively >1.8, include zirconium doped titanium dioxide, silicon doped titanium dioxide, mixed oxide of zinc and tin, mixed oxide of titanium and silicon.

Examples of low refractive index dielectric layers, that is, with a refractive index≤1.6, alternatively ≤1.55, include silicon oxide, zirconium doped silicon oxide, mixed oxide of silicon and aluminum, magnesium fluoride.

An optimal low emissivity coating includes a coating comprising the following layers, in sequence: a first high refractive index layer, a first low refractive index layer, a transparent conductive oxide layer, an optional barrier layer, a second low refractive index layer, and an optional top coat having a low refractive index.

The first high refractive index layer may have a thickness ranging of from 7 to 23 nm, alternatively of from 8 to 20 nm, alternatively of from 9 to 19 nm.

The first low refractive index layer may have a thickness ranging of from 18 to 55 nm, alternatively of from 20 to 50 nm, alternatively of from 25 to 45 nm.

The transparent conductive oxide layer may have a thickness ranging of from 75 to 210 nm, alternatively of from 90 to 175 nm, alternatively of from 105 to 170 nm.

The optional barrier layer may have a thickness ranging of from 0 to 15 nm, alternatively of from 1 to 15 nm, alternatively of from 1 to 12 nm.

The second low refractive index layer may have a thickness ranging of from 40 to 110 nm, alternatively of from 45 to 105 nm, alternatively of from 50 to 95 nm.

The optional top coat may have a thickness ranging of from 2 to 40 nm, alternatively of from 5 to 35 nm, alternatively of from 6 to 30 nm.

The optional topcoat may be a layer of silicon oxide comprising zirconium in an amount of 5 to 40 mol %. Such an uppermost layer allows for tuning the neutral color rendering of the low emissivity coating together with superior durability, for example against scratches. Indeed, the low emissivity coating being positioned towards the passenger compartment, it may be subject to wear and scratches from cleaning or passenger occupations. Such passenger occupations may impact the integrity of the coating, such as rubbing or objects, (umbrellas, balls, clothes, etc.). This uppermost layer may also provide compatibility and adhesion to the fastening elements which will subsequently be used to secure the composite pane within a vehicle frame.

An optimal low emissivity coating may thus include a coating comprising the following layers, in sequence: a first high refractive index layer having a thickness ranging of from 7 to 23 nm, a first low refractive index layer having a thickness ranging of from 18 to 55 nm, a transparent conductive oxide layer having a thickness ranging of from 75 to 210 nm, an optional barrier layer having a thickness ranging of from 0 to 15 nm, a second low refractive index layer having a thickness ranging of from 40 to 110 nm, and an optional top coat having a low refractive index having a thickness ranging of from 2 to 40 nm.

Typically, a pane of clear float glass (soda-lime glass) provided with such an optimal low emissivity coating may have a light transmittance of 85 to 94%.

The present optimal low emissivity coating allows to reach a very low light reflectance inside the vehicle, with values of Rin<4%, or Rin<3%, or even Rin<2%.

The present optimal low emissivity coating may be characterized by an emissivity<0.15 (according to the standard EN 12898).

Yet another example of suitable low emissivity coating may be a low emissivity coating comprising at least two layers of transparent electrically conductive oxide having each a thickness ranging from 20 to 80 nm, which are separated by at least one layer of dielectric material. Such a low emissivity coating may thus comprise n′ TCO layers and n′+1 dielectric layers, with n′≥1, such that each IR layer is surrounded by two dielectric layers. Examples of dielectric layers for such a suitable low emissivity coating include silicon oxide, silicon nitride, zinc oxide, tin oxide, or alloys or mixtures thereof.

According to the invention, an IR reflective coating is present between the outer pane and the inner pane. The first role of such an IR reflective coating is to reflect the infrared portions of the solar radiation, and so reduce the heat transfer towards the interior of the vehicle.

In the scope of specific embodiments of the present invention, one additional role of the IR reflective coating may be to form a light screen for the thermoplastic interlayer and protect the pigments/components of the interlayer against sun rays ageing, while ensuring the thermal performance of the composite pane.

Therefore, the preferred positioning includes at least one IR reflective coating embedded in (that is, within) the thermoplastic interlayer, or at least one IR reflective coating applied directly on the interior-side surface of the outer pane. Such positioning allows for the improved protection of the at least one thermoplastic film layer comprising at least 10% of recycled material from external light rays, and so prevent it from degrading (pigments, etc.), such that quality of the composite pane is maintained over time.

In some other embodiments, the composite pane may comprise one IR reflective coating present embedded in the interlayer, and one IR reflective applied on the interior-side surface of the outer pane.

When the IR reflective coating is embedded in the thermoplastic interlayer, the IR reflective coating is applied to a carrier film that is arranged between two thermoplastic films. The carrier film preferably contains polyethylene terephthalate (PET) and has a thickness of 0.012 to 0.2 mm.

When the IR reflective coating is applied on a surface of a pane, facing the thermoplastic interlayer, it is typically provided by physical vapor deposition methods.

The IR reflective coating may comprise n infrared reflective (IR) layers and n+1 dielectric layers, with n≥1, such that each IR layer is surrounded by two dielectric layers.

The IR reflective coating preferably comprises n infrared reflective (IR) layers and n+1 dielectric layers, with n≥1, such that each IR layer is surrounded by two dielectric layers. Such IR reflective coating offers an optimal comprise between sun protection efficiency and cost.

The IR reflective layer may be made of silver, gold, palladium, platinum or alloys thereof.

The IR reflective layer or functional layer may have a thickness from 2 to 30 nm, alternatively from 5 to 20 nm, alternatively from 7 to 18 nm. These thickness ranges may enable the desired solar control function and/or conductivity (when needed) to be achieved.

The dielectric layers may typically comprise oxides, nitrides, oxynitrides or oxycarbides of Zn, Sn, Ti, Zr, Si, In, Al, Bi, Ta, Hf, Mg, Nb, Y, Ga, Sb, Mg, Cu, Ni, Cr, Fe, V, B or mixtures thereof.

In certain embodiments of the present invention, the dielectric layers may comprise oxides, nitrides, oxynitrides or oxycarbides of Zn, Sn, Ti, Zr, Si, In, Al, Nb, Sb, Ni, Cr, V, Mb, Mg or mixtures thereof. Alternatively, the dielectric layers may comprise oxides, nitrides, oxynitrides of Zn, Sn, Ti, Zr, Si, In, Al, Nb, Sb, Ni, Cr, or mixtures thereof.

These materials may optionally be doped, where examples of dopants include aluminum, zirconium, or mixtures thereof. The dopant or mixture of dopants may be present in an amount up to 15 wt %.

Typical examples of dielectric materials include, but are not limited to, silicon based oxides, silicon based nitrides, zinc oxides, aluminum doped zinc oxides, zinc-based oxides, tin oxides, mixed zinc-tin oxides, silicon nitrides, silicon oxynitrides, titanium oxides, aluminum oxides, zirconium oxides, niobium oxides, aluminum nitrides, bismuth oxides, mixed silicon-zirconium nitrides, and mixtures of at least two thereof, such as for example titanium-zirconium oxides, titanium-niobium oxides, zinc-titanium oxides, zinc-gallium oxides, zinc-indium-gallium oxides (IGZO), zinc-titanium-aluminum oxides (ZTAO), zinc-tin-titanium oxides, zinc-aluminum-vanadium oxides, zinc-aluminum-molybdenum oxides, zinc-aluminum-magnesium oxides, zinc-aluminum-chromium oxides, zinc-aluminum-copper oxides, zinc-titanium-zirconium oxides.

The dielectric layer may consist of a plurality of individual layers comprising or essentially consisting of the above materials.

The dielectric layers may each have a thickness ranging from 0.1 to 200 nm, alternatively from 0.1 to 150 nm, alternatively from 1 to 120 nm, alternatively from 1 to 80 nm. Different dielectric layers may have different thicknesses. That is, the first dielectric layer may have a thickness that is the same or different, greater or smaller, compared to the thickness of the second or third or any other dielectric layer.

Preferred IR reflective coating may typically comprise at least one infrared reflective layer embedded between dielectric layers comprising several layers, among which layers of varying composition in zinc oxide, that is, layers of zinc oxide, zinc oxide doped with aluminum, or layers of mixed oxide of zinc and tin, having a ratio Sn/Zn ranging from 0.5 to 2 by weight, or having a ratio Sn/Zn ranging from 0.02 to 0.5 by weight; layers of silicon nitride; layers of titanium oxide; layers of silicon nitride; layers of mixed oxide of zinc, titanium and aluminum, among others. In some instances, the IR layer(s) may be independently provided with a metallic barrier layer such as Ti, Ni, NiCr, NiCrW, Zr, or the like.

The preferred IR reflective coating may typically comprise a topcoat providing for mechanical and chemical durability selected from titanium oxide, zirconium oxide, silicon nitride, silicon oxide, mixed oxide of titanium and zirconium, mixed oxide of silicon and zirconium, or mixed nitride of silicon and zirconium, and mixtures or alloys thereof.

Such preferred IR reflective coatings have shown particularly good compatibility with the thermoplastic intermediate layer comprising at least 10% of recycled material, while displaying efficiency in protection of the thermoplastic interlayer from sun rays.

Examples suitable IR reflective coating include those coatings comprising: a dielectric layer; a first barrier layer (seed layer); an infrared (IR) reflective layer comprising silver; a second barrier layer and another dielectric layer, wherein the dielectric layers may be selected from zinc oxide, silicon nitride or mixtures thereof. The barriers may be selected from Ni, Cr, W, Ti, or any mixture or alloy thereof. Such a coating may also comprise more than one IR reflective layer.

Further suitable examples of IR reflective coating include a solar control coating comprising
a base dielectric layer comprising at least a base dielectric lower layer and a base dielectric upper layer which is of a different composition to that of the base dielectric lower layer, the base dielectric upper layer comprising either one of zinc oxide or a mixed oxide of Zn and at least one additional material X, in which the ratio X/Zn in the base dielectric upper layer is between 0.02 and 0.5 by weight and in which X is one or more of the materials selected from the group comprising Sn, Al, Ga, In, Zr, Sb, Bi, Mg, Nb, Ta and Ti,
a first infra-red reflecting layer, such as silver, gold, platinum, or mixtures thereof,
a first barrier layer,
a central dielectric layer comprising at least a central dielectric lower layer and a central dielectric upper layer which is of a different composition to that of the central dielectric lower layer, the central dielectric lower layer being in direct contact with the first barrier layer and the central dielectric upper layer; the central dielectric upper layer comprising either one of zinc oxide or a mixed oxide of Zn and at least one additional material Y, in which the ratio Y/Zn in the base dielectric upper layer is between 0.02 and 0.5 by weight and in which Y is one or more of the materials selected from the group comprising Sn, Al, Ga, In, Zr, Sb, Bi, Mg, Nb, Ta and Ti,
a second infra-red reflecting layer, such as silver, gold, platinum, or mixtures thereof,
a second barrier layer,
a top dielectric layer.

A still further example of suitable IR reflective coating includes a solar control coating comprising
a base dielectric layer comprising at least a base dielectric lower layer and a base dielectric upper layer which is of a different composition to that of the base dielectric lower layer, the base dielectric upper layer comprising either one of zinc oxide or a mixed oxide of Zn and at least one additional material X, in which the ratio X/Zn in the base dielectric upper layer is between 0.02 and 0.5 by weight and in which X is one or more of the materials selected from the group comprising Sn, Al, Ga, In, Zr, Sb, Bi, Mg, Nb, Ta and Ti,
a first infra-red reflecting layer, such as silver, gold, platinum, or mixtures thereof,
a first barrier layer,
a second dielectric layer comprising at least a second dielectric lower layer and a second dielectric upper layer which is of a different composition to that of the second dielectric lower layer, the second dielectric lower layer being in direct contact with the first barrier layer and the second dielectric upper layer; the second dielectric upper layer comprising either one of zinc oxide or a mixed oxide of Zn and at least one additional material Y, in which the ratio Y/Zn in the second dielectric upper layer is between 0.02 and 0.5 by weight and in which Y is one or more of the materials selected from the group comprising Sn, Al, Ga, In, Zr, Sb, Bi, Mg, Nb, Ta and Ti,
a second infra-red reflecting layer, such as silver, gold, platinum, or mixtures thereof,
a second barrier layer,
a third dielectric layer comprising at least a third dielectric lower layer and a third dielectric upper layer which is of a different composition to that of the third dielectric lower layer, the third dielectric lower layer being in direct contact with the second barrier layer and the third dielectric upper layer; the third dielectric upper layer comprising either one of zinc oxide or a mixed oxide of Zn and at least one additional material Y, in which the ratio Y/Zn in the third dielectric upper layer is between 0.02 and 0.5 by weight and in which Y is one or more of the materials selected from the group comprising Sn, Al, Ga, In, Zr, Sb, Bi, Mg, Nb, Ta and Ti,
a third infra-red reflecting layer, such as silver, gold, platinum, or mixtures thereof,
a third barrier layer,
a top dielectric layer.

In such examples of IR reflective coatings, the base dielectric upper layer may be in direct contact with the first infra-red reflecting layer. The central dielectric upper layer may be in direct contact with the second infra-red reflecting layer. The upper layers of both the base dielectric layer and the central, first and second dielectric layer may independently have a geometrical thickness within the range of about 3 to 20 nm. One or both of the additional materials X and Y may be Sn and/or Al. The proportion of Zn in the mixed oxide that forms the base dielectric upper layer and/or that which forms the central dielectric upper layer may be such that ratio X/Zn and/or the ratio Y/Zn is between about 0.03 and 0.3 by weight. The first and/or second and/or third barrier layer may be a layer comprising Ti and/or comprising an oxide of Ti, and they may each independently have a geometrical thickness of from 0.5 to 7 nm. The base dielectric upper layer and/or the central and/or the second and/or third dielectric upper layer may independently have a geometrical thickness <20 nm, alternatively <15 nm, alternatively <13 nm, alternatively <11 nm, and >3 nm, alternatively >5 nm, alternatively >10 nm. The infra-red reflecting layers may each independently have a thickness of from 2 to 22 nm, alternatively of from 5 to 20 nm, alternatively of from 8 to 18 nm. The top dielectric layer may comprise at least one layer which comprises a mixed oxide of Zn and at least one additional material W, in which the ratio W/Zn in that layer is between 0.02 and 2.0 by weight and in which W is one or more of the materials selected from the group comprising Sn, Al, Ga, In, Zr, Sb, Bi, Mg, Nb, Ta and Ti. A toppcoat may be present selected from titanium oxide, zirconium oxide, silicon nitride, silicon oxide, mixed oxide of titanium and zirconium, mixed oxide of silicon and zirconium, or mixed nitride of silicon and zirconium, and mixtures or alloys thereof.

Typically, a pane of clear float glass (soda-lime glass) provided with such an IR reflective coating may have a light transmittance of 70 to 80%.

The IR reflective coating may be an electrically conductive coating such as an electrically conductive heated window coating or a single-film or multi-film coating capable of functioning as an antenna.

The present invention also relates to the method to obtain a composite pane comprising the steps of:
1) Providing for an outer pane having an outer-side surface and an interior-side surface,
2) Providing for an inner pane having an outer-side surface and an interior-side surface, having a low emissivity coating on the interior-side surface of said inner pane,
3) Providing for a thermoplastic interlayer formed from at least one thermoplastic film layer comprising at least 10% of recycled material and wherein said at least one thermoplastic film layer has a light transmittance of from 1 to 20%,
4) Providing for at least one infrared reflective coating, either on the interior-side surface of the outer pane, or within the thermoplastic interlayer,
5) assembling the interior-side surface of the outer pane and the outer-side surface of the inner pane by means of the thermoplastic interlayer to provide for a laminated glazing.

The steps of provision of the inner pane with the low emissivity coating, and the provision of the outer pane when it comprises the at least one infrared reflective coating include a deposition step, using a method selected among CVD, PECVD, PVD, magnetron sputtering, or the like.

Different layers of the respective coatings may be deposited using different techniques.

When indium tin oxide is used, it is preferably deposited by means of magnetron-enhanced cathodic sputtering with a target of indium tin oxide. The target preferably contains from 75 wt.-% to 95 wt-% indium oxide and from 5 wt.-% to 25 wt.-% tin oxide as well as production-related admixtures. The deposition of the indium tin oxide or tin-doped indium oxide is preferably done under a non-reactive gas atmosphere, for example, argon. A small amount of oxygen can also be added to the non-reactive gas, for example, to improve the homogeneity of the functional layer.

Alternatively, the target can preferably contain at least from 75 wt.-% to 95 wt-% indium and from 5 wt.-% to 25 wt.-% tin. The deposition of the indium tin oxide is preferably done under addition of oxygen as the reactive gas during cathodic sputtering.

The at least one infrared reflective coating may be arranged on a carrier film embedded in the interlayer, such as discussed above.

The glass panes provided with the respective coatings may subsequently be subjected to a thermal treatment, to reinforce the glass panes, and to optimize performances of said coatings.

The thermal treatments comprise heating the glazing to a temperature of at least 560° C. in air, for example between 560° C. and 700° C., in particular around 630° C. to 670° C., during around 3, 4, 6, 8, 10, 12 or even 15 minutes according to the heat-treatment type and the thickness of the glazing. The treatment may comprise a rapid cooling step after the heating step, to introduce a stress difference between the surfaces and the core of the glass so that in case of impact, the so-called tempered glass sheet will break safely in small pieces. If the cooling step is less strong, the glass will then simply be heat-strengthened and in any case offer a better mechanical resistance.

The step of assembling the 2 sheets of glass and the at least one interlayer may be a lamination step for flat glass, or may be a bending step for curved laminated glass, which bending step includes the steps of first bending the sheets of glass and second, laminating said bent sheets of glass.

The composite pane may then be subject to enamel deposition or preparation for inclusion within a frame.

The present composite pane may thus be characterized by a light transmittance of 1 to 10%, which ensures the best possible compromise between vision outside through the roof and good thermal properties. This light transmittance may be reached by the selection of the appropriate thermoplastic film layer comprising at least 10% of recycled material and having a light transmittance of from 1 to 20% (III. A, 2°).

The combination of the IR reflective coating inserted between the outer and inner pane, with the selected thermoplastic film layer comprising at least 10% of recycled material allows to reach a light reflectance observed from the outside Rext<13%.

The low emissivity coating, positioned on the inner-side of the inner pane, towards the vehicle compartment, together with good durability, allows to reach a light reflectance observed from the inside Rin<8%, or Rin<4%, or Rin<3%, or even Rin<2%, depending on the selected type of low emissivity coating.

The present invention also relates to the use of the composite pane according to the invention as a window pane of a vehicle.

The composite pane according to the invention fulfills the high safety requirements in the vehicle sector. These requirements are typically checked by standardized fracture, impact and scratch tests, such as the ECE R43 ball drop test, well known to the skilled person.

The present composite pane may particularly be used as a roof for a vehicle.

A vehicle includes those vehicles useful for transportation on road, in air, in and on water, in particular cars, busses, tramways, trains, ships, aircraft, spacecraft, space stations and other motor vehicles.

The window panes include rear window, side windows, sun roof, panoramic roof or any other window useful for a car, or any glazing for any other transportation device, where light transmittance >70% is not a mandatory feature.

The window pane preferably is a roof panel of a vehicle, in particular a passenger car, as it may best provide for solar control over a wide surface as compared to side windows.

The present pane may be also be useful in architectural applications. Architectural applications include displays, windows, doors, partitions, shower panels, and the like.

In some instances, the composite pane may serve as a heatable vehicle glazing.

In the following, the invention is explained in detail with reference to drawings and exemplary embodiments. The drawings are schematic representations and not to scale. The drawings in no way restrict the invention.

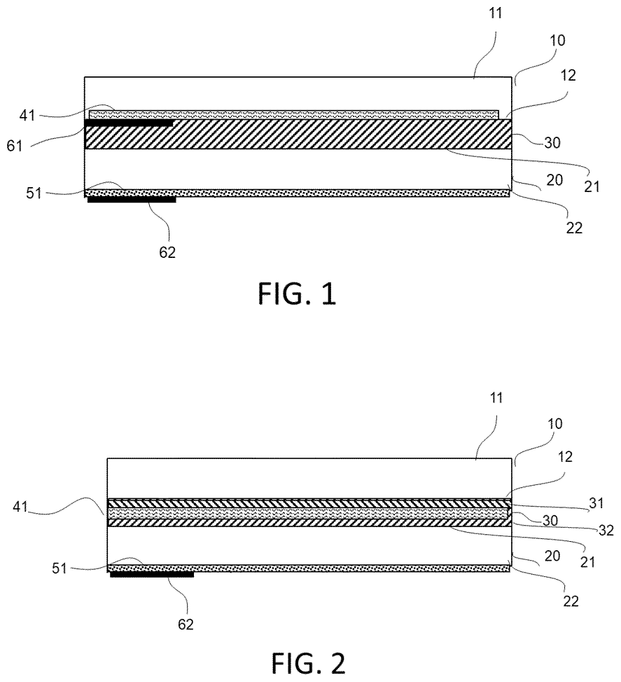

FIG. 1 depicts a cross-section through an embodiment of the composite pane according to the invention. The composite pane comprises an outer pane 10 and an inner pane 20 that are joined to one another via a thermoplastic interlayer 30. The composite pane has a size of approx. 1 m² and is intended for use as a roof panel of a passenger car, with the outer pane 10 intended to face the external environment and the inner pane 20 intended to face the vehicle interior. The outer pane 10 has an outer-side surface 11 and an interior-side surface 12. The inner pane 20 has an outer-side surface 21 and an interior-side surface 22. The outer-side surface 11 and 21 face the external environment in the installed state; the interior-side surfaces 12 and 22 face the vehicle interior in the installed position. The interior-side surface 12 of the outer pane 10 and the outer-side surface 21 of the inner pane 20 face one another. The outer pane 10 and the inner pane 20 contain clear soda lime glass. They may each have a thickness of 2.1 mm, or the one pane may have a thickness of 1.6 mm, and the other pane may have a thickness of 2.1 mm.

The thermoplastic interlayer 30 is formed from at least one thermoplastic film layer comprising at least 10% of recycled material, said at least one thermoplastic film layer having a light transmittance of from 1 to 20%. In preferred embodiments, the at least one thermoplastic film layer comprises at least 60% of recycled material is made of polyvinyl butyral (PVB). In most preferred embodiments, the thermoplastic interlayer 30 is formed from one thermoplastic film layer comprising 100% recycled material, and has a light transmittance of from 1 to 20%.

The thermoplastic interlayer 30 may generally have a thickness of 0.76 mm.

In FIG. 1, an IR reflective coating 41 is arranged on the interior-side surface 12 of the outer pane 10. The IR reflective coating 41 may extend over the entire surface 12, or may extend over the entire surface minus a circumferential frame-shaped coating-free region with a width of 1 to 10 mm. The coating-free region is hermetically sealed by bonding with the thermoplastic interlayer 30. The IR reflective coating 41 is thus advantageously protected against damage and corrosion. The IR reflective coating 41 comprises, for example, at least two functional layers that at least contain silver or are made of silver and have a layer thickness between 10 nm and 20 nm, with each functional layer arranged between two dielectric layers made of the materials listed above, related to the IR reflective coating.

A low emissivity coating 51 is arranged on the interior-side surface 22 of the inner pane 20. The coating 51 may be the optimal low emissivity coating discussed above.

Enamel coatings or dark prints 61 and 62 may be provided as obscuration bands typically present on vehicle glazings, intended to be mounted on a vehicle frame. Typical fastening methods may be employed to secure the composite pane on a vehicle.

The IR reflective coating 41 results in reduced heating such that the thermoplastic film layer comprising at least 10% of recycled material is not altered or degraded by the infrared radiation. On the one hand, the low emissivity coating 51 reduces the radiation of heat towards the passenger compartment in warmer climatic conditions, or out of said passenger compartment in colder climatic conditions. The optimal low emissivity coating discussed above may further provide for a low reflectance inside the vehicle with values of Rin<4%, or Rin<3%, or even Rin<2%, together with high mechanical and chemical durability.

The selected combination of the various elements allows for the use of recycled materials within high performance vehicle glazing, alleviating cost constraints while ensuring safety and thermal performances. Further cost constraints may be lessened by the combined use of clear or extra clear float glass, while further improving thermal management by the avoidance of heat absorption within the outer and/or inner panes.

FIG. 2 depicts a cross-section through a second embodiment of the composite pane according to the invention, compatible with the other embodiments of the invention. The main elements are the same as in FIG. 1, except in FIG. 2, the IR reflective coating 41 is arranged on a PET carrier film inserted within the thermoplastic interlayer 30. In this embodiment, the thermoplastic interlayer 30 is formed from at least one thermoplastic film layer 32 comprising at least 10% of recycled material, said at least one thermoplastic film layer having a light transmittance of from 1 to 20%; and from at least one thermoplastic film layer 31 which is preferably clear, having a light transmittance >80%. The at least one thermoplastic film layer 32 comprising at least 10% of recycled material is preferably positioned between the IR reflective coating on a carrier film and the inner pane, such that it is protected from IR rays.

The thickness of the thermoplastic interlayer 30 may range of from 0.70 to 1.80 mm, because of the IR reflective film arranged on a carrier film having a thickness of from 0.01 to 0.20 mm is present within said thermoplastic interlayer.

### EXAMPLES

Various composite panes were prepared, comprising the following elements, and properties as outlined in Table 2.

### Components

The outer and inner glass sheets were selected from clear float glass of 2.1 mm or 1.6 mm.

The IR reflective coating were selected from
a. IRa: IR reflective coating having 2 silver layers embedded in dielectric layers comprising sublayers of zinc oxide having varying compositions, having a light transmittance on clear glass of 2.1 mm=72-75%;
b. IRb and IRb′: IR reflective coatings having 2 silver layers embedded in dielectric layers on a PET carrier layer.

The interlayers were characterized by their composition based on 100% recycled material, and their light transmittance, which for each is inferior to 20%, or even inferior to 15%, with the thickness indicated in mm. Said interlayers have varying shades of grey according to the desired light transmittance.

The low emissivity coatings (Low e) were selected from
a. low e-a: see Table 1;
b. low e-b: standard fluorine doped tin oxide, on a silicon oxide dielectric layer; both low emissivity coatings having a light transmittance on clear glass of 2.1 mm=89-92%.

TABLE 1

| sequence from glass | TiZrOx | SiO2 | InSnOx | SiO2 | SiZrOx |
|---|---|---|---|---|---|
| refractive index | 2.35 | 1.47 | 1.85 | 1.47 | 1.54 |
| Physical thickness (nm) | 14 | 35 | 136 | 77 | 17 |

### Results

The assessment of the performances was carried out according to automotive reference ISO9050. The values of light transmittance—TL (%), energy transmittance—TE (%), reflectance from the glass side—Rout (%), reflectance from the coating side—Rin (%) have been obtained under Illuminant A, at a 2° observer, according to ISO9050.

The composite panes were also tested according to ECE R43—“ball drop tests”.

In the first test (BDT1), a steel ball weighing 227 g was dropped onto the outer pane from a height of 8.5 m. This test simulates the impact of a stone on the outside of the laminated glass. The test was considered passed if the ball was stopped by the laminated glass and this was not penetrated and if the amount of splinters on the side facing away from the impact falls below a certain (thickness-dependent) amount.

In the second test (BDT2), a steel ball weighing 2260 g was dropped onto the inner pane from a height of m. This test simulates the impact of the head of a vehicle occupant on the laminated glass. The test was considered passed if the ball was stopped by the laminated glass and it did not penetrate within 5 seconds after rupture.

TABLE 2

| | Outer glass | | Interlayer | | Low | TL | TE | Rout | Rin |
|---|---|---|---|---|---|---|---|---|---|
| Ex | (mm) | IR | (mm) | Inner glass | e | (%) | (%) | (%) | (%) |
| Ex. 1 | 2.1 | IRa | 0.76 - recycled with TL = 1.5% | 2.1 | low e- | 1.3 | 1.6 | 12.4 | 1.7 |
| | | | | | a | | | | |
| Ex. 2 | 2.1 | IRa | 0.76 - recycled with TL = 5% | 2.1 | low e- | 4.2 | 3.8 | 12.4 | 1.8 |
| | | | | | a | | | | |
| Ex. 3 | 2.1 | IRa | 0.76 - recycled with TL = 8% | 2.1 | low e- | 6.1 | 5.0 | 12.4 | 1.8 |
| | | | | | a | | | | |
| Ex. 4 | 2.1 | IRa | 0.76 - recycled with TL = 13% | 1.6 | low e- | 9.4 | 7.2 | 12.4 | 1.9 |
| | | | | | a | | | | |
| Ex. 5 | 2.1 | IRb | 0.38 clear pvb + 0.76 - recycled | 2.1 | low e- | 4.5 | 5.2 | 6.6 | 1.8 |
| | | | with TL = 5% | | a | | | | |
| Ex. 6 | 2.1 | IRb | 0.38 clear pvb + 0.76 - recycled | 2.1 | low e- | 6.6 | 6.7 | 6.6 | 1.8 |
| | | | with TL = 8% | | a | | | | |
| Ex. 7 | 2.1 | IRb | 0.38 clear pvb + 0.76 - recycled | 1.6 | low e- | 1.3 | 2.3 | 6.6 | 7.6 |
| | | | with TL = 1.5% | | b | | | | |
| Ex. 8 | 2.1 | IRb′ | 0.38 clear pvb + 0.76 - recycled | 1.6 | low e- | 1.2 | 1.8 | 5.1 | 7.6 |
| | | | with TL = 1.5% | | b | | | | |

It can be seen from Table 2 that the composite panes reached the expected opto-energetical performances, with
a. light transmittance ranging of from 1 to 10%;
b. light reflectance observed from the outside less than 13%;
c. light reflectance observed from the inside less than 8%.

The energy transmittance TE are also indicative of the high solar protection highly insulating properties of the composite pane, such that the inside environment is not impacted by heat rays from the outside.

When an optimal low emissivity coating is used (low e-a), light reflectance observed from the inside may reach values even less than 4%, less than 2%. This allows for a high internal comfort for the vehicle occupants without impacting the visual comfort of the occupants.

All the composite panes from Examples 1 to 8 have values of transmittance index A according to WO02019/110172 which are <0.02.

All the composite panes from Examples 1 to 8 have passed both “ball drop tests”, indicating the suitability of the composite pane as a window pane for a vehicle, satisfying the safety requirements of adhesion of the thermoplastic film layer comprising at least 10% of recycled material.

1: A composite pane, comprising:
a. an outer pane having an outer-side surface and an interior-side surface,
b. an inner pane having an outer-side surface and an interior-side surface, and
c. a thermoplastic interlayer that joins the interior-side surface of the outer pane to the outer-side surface of the inner pane,
wherein the composite pane has, between the outer pane and the inner pane, at least one infrared reflective coating, and
wherein the composite pane has, on the interior-side surface of the inner pane, a low emissivity coating,
wherein the thermoplastic interlayer is formed from at least one thermoplastic film layer comprising at least 10% of recycled material,
and wherein said at least one thermoplastic film layer has a light transmittance of from 1 to 20% (Ill. A, 2°).

2: The composite pane according to claim 1, wherein the at least one thermoplastic film layer comprising at least 10% of recycled material contains polyvinyl butyral (PVB), copolymers of vinyl ethylene and vinyl acetate (EVA), polyurethane (PU), polyvinyl chloride (PVC), and/or mixtures thereof and/or copolymers thereof.

3: The composite pane according to claim 1, wherein the thermoplastic interlayer is formed by one or a plurality of thermoplastic films, wherein at least one film comprises at least 10% recycled material.

4: The composite pane according to claim 1, wherein the low emissivity coating comprises a functional layer that contains a transparent conductive oxide (TCO), selected from indium tin oxide, antimony-doped or fluorine-doped tin oxide, gallium- and/or aluminum-doped zinc oxide, mixed indium zinc, vanadium oxide, tungsten and/or magnesium doped vanadium oxide, niobium-doped titanium oxide, cadmium stannate and/or zinc stannate.

5: The composite pane to claim 1, wherein the low emissivity coating comprises a functional layer that contains a transparent conductive oxide (TCO), selected from indium tin oxide, antimony-doped or fluorine-doped tin oxide and/or aluminum-doped zinc oxide (ZnO:Al) and/or gallium-doped zinc oxide (ZnO:Ga).

6: The composite pane according to claim 4, wherein the low emissivity coating comprises the following layers, in sequence: a first high refractive index layer, a first low refractive index layer, a transparent conductive oxide layer, an optional barrier layer, a second low refractive index layer, and an optional top coat having a low refractive index.

7: The composite pane according to claim 1, wherein the at least one infrared reflective coating is applied directly to the interior-side surface of the outer pane or is arranged on a carrier film embedded in the interlayer.

8: The composite pane according to claim 1, wherein the reflective coating comprises n infrared reflective (IR) layers and n+1 dielectric layers, with n≥1, such that each IR layer is surrounded by two dielectric layers.

9: The composite pane according to claim 8, wherein the IR reflective coating comprises n infrared reflective (IR) layers and n+1 dielectric layers, with n≥2, such that each IR layer is surrounded by two dielectric layers.

10: The composite pane according to claim 9, wherein the IR reflective coating comprises at least one infrared reflective layer embedded between dielectric layers where each dielectric layer comprises several layers.

11: The composite pane according to claim 1, wherein the infrared reflective coating comprises a topcoat selected from titanium oxide, zirconium oxide, silicon nitride, silicon oxide, mixed oxide of titanium and zirconium, mixed oxide of silicon and zirconium, mixed nitride of silicon and zirconium, and mixtures or alloys thereof.

12: The composite pane according to claim 1, wherein the inner and outer panes are selected from among clear and extra-clear soda-lime glass.

13: A method to obtain a composite pane comprising:
1) Providing for an outer pane having an outer-side surface and an interior-side surface,
2) Providing for an inner pane having an outer-side surface and an interior-side surface, having a low emissivity coating on the interior-side surface of said inner pane,
3) Providing for a thermoplastic interlayer formed from at least one thermoplastic film layer comprising at least 10% of recycled material and wherein said at least one thermoplastic film layer has a light transmittance of from 1 to 20%,
4) Providing for at least one infrared reflective coating, either on the interior-side surface of the outer pane, or within the thermoplastic interlayer,
5) assembling the interior-side surface of the outer pane and the outer-side surface of the inner pane by means of the thermoplastic interlayer to provide for a laminated glazing.

14. (canceled)

15: The composite pane according to 10, wherein each dielectric layer comprises layers of varying composition, the layers of varying composition selected from the group consisting of zinc oxide; silicon nitride; titanium oxide; and mixed oxides of zinc, titanium and aluminum.

16: The composite pane according to 15, wherein the zinc oxide comprises zinc oxide, zinc oxide doped with aluminum, or mixed oxide of zinc and tin having a tin/zinc ratio ranging from 0.5 to 2 by weight or having a zinc/tin ratio ranging from 0.02 to 0.5 by weight.
